(19) United States
(12) Patent Application Publication
(10) Pub. No.: US 2026/0189849 A1
(43) Pub. Date: Jul. 2, 2026

(54) BEAM-FORMING FUNCTION IMPLEMENTATION METHOD AND SYSTEM

(71) Applicant: GOERTEK INC., Weifang, Shandong (CN)

(72) Inventor: Zongxu YANG, Weifang, Shandong (CN)

(21) Appl. No.: 18/857,593

(22) PCT Filed: Sep. 20, 2022
(86) PCT No.: PCT/CN2022/119884

§ 371 Date: Oct. 17, 2024

(30) Foreign Application Priority Data
Jun. 30, 2022 (CN) 202210763779.7

(51) Int. Cl. H04R 1/40; G01S 5/14; H04R 3/00

(52) U.S. Cl. CPC H04R 1/406; G01S 5/14; H04R 3/005

(57) ABSTRACT

The present application discloses a beam-forming function implementation method and system, an electronic device and a storage medium, belonging to the technical field of audio acquisition. The beam-forming function implementation method includes: using a positioning device to collect a positioning signal of a target device, and using the positioning signal to determine position information of the target device; according to the position information, selecting a main microphone and an auxiliary microphone from a microphone array; using the main microphone and the auxiliary microphone to construct a dual-microphone beam-forming architecture, and using the dual-microphone beam-forming architecture to collect sound signals. The present application ensures sound signal collection effect and enhances the stability of the beam-forming function.

This application claims priority to a Chinese patent application No. 202210763779.7, entitled “BEAM-FORMING FUNCTION IMPLEMENTATION METHOD AND SYSTEM”, filed with the China Patent Office on Jun. 30, 2022, the entire contents of which are incorporated by reference in this application.

### TECHNICAL FIELD

The present application relates to the technical field of audio acquisition, and in particular, to a method and system for implementing beam-forming function.

### BACKGROUND

Beam-forming is a general signal processing technology for controlling the direction of propagation and the reception of radio frequency signals. Electronic devices such as smart speakers and smartphones with beam-forming functions are becoming more and more popular. In related technologies, fixed dual microphones are usually used to implement beam-forming functions, and an angle between the sound source and the dual microphones has a great influence on the collection effect of sound signals.

Therefore, how to ensure the collection effect of sound signals and improve the stability of the beam-forming function is a technical problem that those skilled in the art currently need to solve.

### SUMMARY

The purpose of this application is to provide a beam-forming function implementation method and system, an electronic device and a storage medium, which can ensure the collection effect of sound signals and improve the stability of the beam-forming function.

In order to solve the above technical problems, the present application provides a method for implementing beam-forming function, which is applied to an electronic device including a positioning device and a microphone array, wherein the microphone array includes at least three microphones, and wherein the method for implementing beam-forming function includes:
collecting, using the positioning device, a positioning signal of a target device, and determining position information of the target device according to the positioning signal;
selecting a main microphone and an auxiliary microphone from the microphone array according to the position information; and
constructing a dual-microphone beam-forming architecture using the main microphone and the auxiliary microphone, and collecting sound signals using the dual-microphone beam-forming architecture.

Optionally, the positioning device is a UWB module including a first antenna and a second antenna;
accordingly, the collecting, using the positioning device, a positioning signal of a target device, and determining, using the positioning signal, position information of the target device includes:
collecting UWB signal of the target device respectively using the first antenna and the second antenna of the UWB module;
calculating a time difference between the UWB signal respectively arriving at the first antenna and the second antenna; and
determining the position information of the target device according to the time difference and an antenna distance, wherein the antenna distance is a distance between the first antenna and the second antenna.

Optionally, the selecting a main microphone and an auxiliary microphone from the microphone array according to the position information includes:
determining a first type angle ∠POM corresponding to the microphone according to the position information; wherein P is a coordinate point of the target device, O is a target center point, and M is a coordinate point of the microphone; the target center point is a point having the same distance from all the microphones, and the target center point and all the microphones are in the same plane;
setting the microphone with the smallest first type angle ∠POM as the main microphone;
determining a plurality of second type angles ∠PQN corresponding to the main microphone; wherein Q is a coordinate point of other microphones adjacent to the main microphone, and N is a coordinate point of the main microphone; and
setting the microphone corresponding to the Q point where the second type angle ∠PQN is minimized as the auxiliary microphone.

Optionally, the selecting a main microphone and an auxiliary microphone from the microphone array according to the position information includes:
connecting a target center point and each of the microphones so as to divide an area where the target device is located into a plurality of sub-areas; wherein the target center point is a point having the same distance from all the microphones, and the target center point and all the microphones are in the same plane;
determining the sub-area where the target device is located according to the position information, and setting two microphones corresponding to the sub-area where the target device is located as alternative microphones;
setting the alternative microphone closest to the target device as the main microphone; and
setting the microphone closest to the target device except the alternative microphone as the auxiliary microphone.

Optionally, the method further includes:
if the target device is located at a boundary line of the sub-area, setting the microphone closest to the target device as the main microphone.

The present application also provides a system for implementing beam-forming function, which is applied to an electronic device including a positioning device and a microphone array, wherein the microphone array includes at least three microphones, and wherein the system for implementing beam-forming function includes:
a position information determination module configured to collect, using the positioning device, a positioning signal of a target device, and determine position information of the target device according to the positioning signal;
a microphone selection module configured to select a main microphone and an auxiliary microphone from the microphone array according to the position information; and
a beam-forming function implementation module configured to construct a dual-microphone beam-forming architecture using the main microphone and the auxiliary microphone, and collect sound signals using the dual-microphone beam-forming architecture.

The present application also provides an electronic device, wherein the electronic device includes a memory, a central controller, a positioning device and a microphone array, wherein the microphone array includes at least three microphones, and wherein the central controller, when executing a computer program stored on the memory, implements operations including:
collecting, using the positioning device, a positioning signal of a target device, and determining position information of the target device according to the positioning signal;
selecting a main microphone and an auxiliary microphone from the microphone array according to the position information; and
constructing a dual-microphone beam-forming architecture using the main microphone and the auxiliary microphone, and collecting sound signals using the dual-microphone beam-forming architecture.

Optionally, the electronic device is a smart speaker or a mobile phone, and the target device is a smart wearable device or a mobile phone.

Optionally, the positioning device is a UWB module or a Bluetooth module.

The present application also provides a storage medium, on which a computer program is stored, wherein when the computer program is executed, steps of the method for implementing beam-forming function as described above are implemented.

The present application provides a method for implementing beam-forming function, which is applied to an electronic device including a positioning device and a microphone array, wherein the microphone array includes at least three microphones, and wherein the method for implementing beam-forming function includes: collecting, using the positioning device, a positioning signal of a target device, and determining, using the positioning signal, position information of the target device; selecting a main microphone and an auxiliary microphone from the microphone array according to the position information; constructing a dual-microphone beam-forming architecture using the main microphone and the auxiliary microphone, and collecting sound signals using the dual-microphone beam-forming architecture.

The electronic device provided by the present application includes a positioning device and a microphone array, wherein the microphone array includes at least three microphones, and the positioning device is used to collect the positioning signal of the target device, and then the positioning information of the target device is determined using the positioning signal. According to the positioning information of the target device, a main microphone and an auxiliary microphone are selected from the microphone array, and a dual-microphone beam-forming architecture is constructed using the main microphone and the auxiliary microphone to collect sound signals. The above scheme can select the main microphone and the auxiliary microphone to construct the dual-microphone beam-forming architecture according to the position of the target device, which can eliminate the influence of the sound source and the dual microphone angle on the sound signal collection effect, and improve the stability of the beam-forming function. The present application also provides a system for implementing beam-forming function, a storage medium and an electronic device, which have the above-mentioned beneficial effects and will not be repeated here.

### BRIEF DESCRIPTION OF DRAWINGS

In order to more clearly illustrate the embodiments of the present application, the following is a brief introduction to the drawings required for use in the embodiments. Obviously, the drawings described below are only some embodiments of the present application. For those skilled in the art, other drawings can be obtained based on these drawings without paying any creative work.

FIG. 1 is a flow chart of a method for implementing beam-forming function provided in an embodiment of the present application;

FIG. 2 is a schematic diagram of a microphone array structure provided in an embodiment of the present application;

FIG. 3 is a schematic diagram of a main microphone selection principle provided in an embodiment of the present application;

FIG. 4 is a schematic diagram of an auxiliary microphone selection principle provided in an embodiment of the present application;

FIG. 5 is a schematic diagram showing a principle of selecting a main microphone and an auxiliary microphone provided in an embodiment of the present application;

FIG. 6 is a schematic diagram of the architecture of a smart speaker provided in an embodiment of the present application;

FIG. 7 is a schematic diagram showing a smart speaker positioning principle provided in an embodiment of the present application;

FIG. 8 is a schematic diagram of a smart speaker microphone layout provided in an embodiment of the present application.

### DETAILED DESCRIPTIONS

In order to make the purpose, technical solution and advantages of the embodiments of the present application clearer, the technical solution in the embodiments of the present application will be clearly and completely described below in conjunction with the drawings in the embodiments of the present application. Obviously, the described embodiments are part of the embodiments of the present application, not all of the embodiments. Based on the embodiments in the present application, all other embodiments obtained by those skilled in the art without creative work are within the scope of protection of this application.

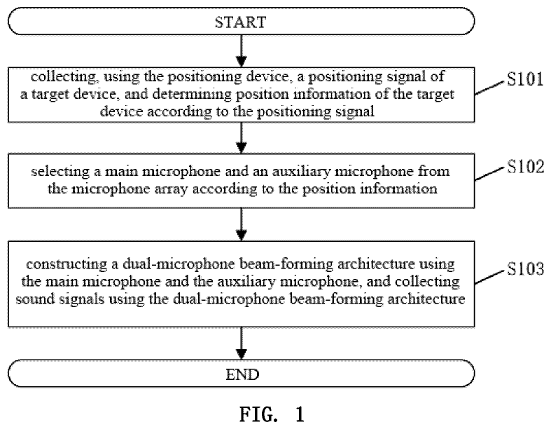

Hereinafter, please refer to FIG. 1, which is a flow chart of a method for implementing beam-forming function provided in an embodiment of the present application.

Specific steps may include:

S101: collecting a positioning signal of a target device using a positioning device, and determining position information of the target device using the positioning signal;

Here, this embodiment can be applied to electronic devices including a positioning device and a microphone array, and the electronic devices can be devices with sound collection functions, such as smart speakers and mobile phones. The target device can be a smart wearable device or a mobile phone that a user can carry with him. The smart wearable device can be a smart watch, a smart bracelet, a VR helmet, AR glasses, etc.

The scenarios in which this embodiment can be applied include but are not limited to the following scenarios:
Scenario 1: There is a smart speaker A with beam-forming function in the room. When a user A, who is carrying a mobile phone B, speaks in the room, the smart speaker A collects the user's voice signal by constructing a dual-microphone beam-forming architecture, so that the smart speaker A can execute instructions corresponding to the content of user A's speech.
Scenario 2: User A and user B are in the same room. When user A, who is carrying a mobile phone B, is talking in the room, user B uses a mobile phone A′ with the beam-forming function to collect the user's voice signal so that the mobile phone A′ can record what user A is saying.

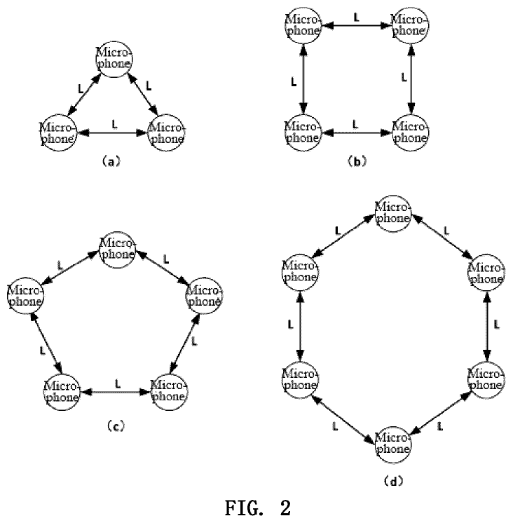

The microphone array includes at least three microphones, and the distance between each microphone can be a fixed value. Please refer to FIG. 2, which is a schematic diagram of the microphone array structure provided in an embodiment of the present application. In FIG. 2, a, b, c and d are four microphone array arrangement methods, and L represents the distance between two adjacent microphones. Of course, this embodiment can also use other microphone array arrangements other than FIG. 2 on the premise of ensuring that the distances between adjacent microphones are the same.

In this step, the positioning device can be used to collect the positioning signal sent by the target device, and then the positioning signal is used to determine the position information of the target device. The above-mentioned position information specifically refers to the relative position of the target device relative to the electronic device.

S102: selecting a main microphone and an auxiliary microphone from the microphone array according to the position information;

After obtaining the position information of the target device, two microphones that are most suitable for implementing the dual-microphone beam-forming function can be selected as the main microphone and the auxiliary microphone according to the position information.

S103: constructing a dual-microphone beam-forming architecture using the main microphone and the auxiliary microphone, and collecting sound signals using the dual-microphone beam-forming architecture.

After the main microphone and the auxiliary microphone are determined, a dual-microphone beam-forming architecture can be constructed using the main microphone and the auxiliary microphone, and the main microphone and the auxiliary microphone in the dual-microphone beam-forming architecture are used to collect sound signals.

The position of the target device is the position of the sound source. When the user wears the target device and speaks to the electronic device, the electronic device can collect the user's voice signal using the dual-microphone beam-forming architecture.

The electronic device provided in this embodiment includes a positioning device and a microphone array, the microphone array includes at least three microphones, and the positioning device is used to collect a positioning signal of the target device, and then positioning information of the target device is determined using the positioning signal. According to the positioning information of the target device, a main microphone and an auxiliary microphone are selected from the microphone array, and a dual-microphone beam-forming architecture is constructed using the main microphone and the auxiliary microphone to collect sound signals. The above scheme can select the main microphone and the auxiliary microphone to construct the dual-microphone beam-forming architecture according to the position of the target device, which can eliminate the influence of the sound source and the dual microphone included angle on the sound signal collection effect, and improve the stability of the beam-forming function.

As a further introduction to the embodiment corresponding to FIG. 1, the positioning device may be a UWB module or a Bluetooth module. In the following description, the positioning device which is a UWB module including a first antenna and a second antenna is taken as an example to illustrate the process of determining the position information of the target device: using respectively the first antenna and the second antenna of the UWB module to collect a UWB signal of the target device; calculating a time difference between when the UWB signal arrives respectively at the first antenna and at the second antenna; determining the position information of the target device according to the time difference and an antenna distance; wherein the antenna distance is a distance between the first antenna and the second antenna.

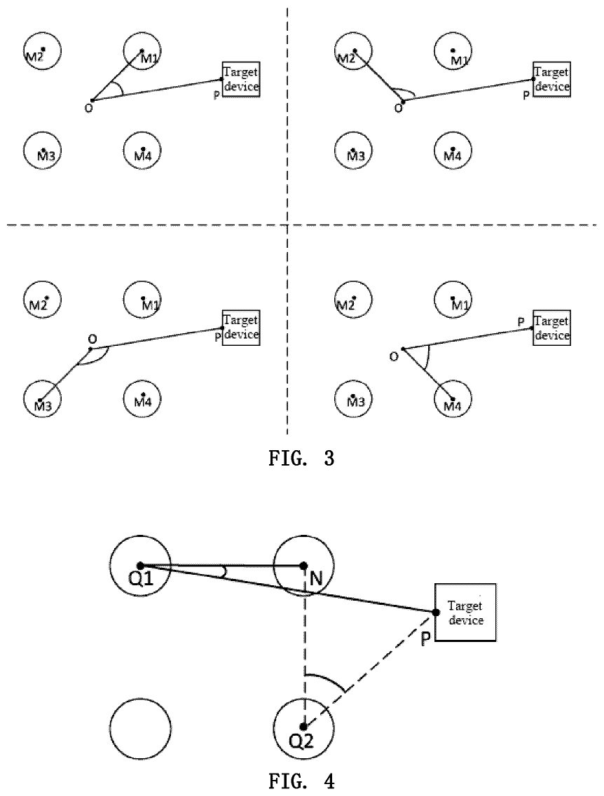

As a further introduction to the embodiment corresponding to FIG. 1, the specific process of selecting the main microphone by comparing the angles is as follows: determining a first type angle ∠POM corresponding to the microphone according to the position information; wherein, P is a coordinate point of the target device, O is a target center point, and M is a coordinate point of the microphone; wherein the target center point is a point having the same distance from all the microphones, and the target center point and all the microphones are in the same plane; setting the microphone with the smallest first type angle ∠POM as the main microphone. Please refer to FIG. 3, which is a schematic diagram of a main microphone selection principle provided in an embodiment of the present application. In FIG. 3, P is a coordinate point of the target device, O is a target center point, and M1, M2, M3 and M4 are coordinate points of the four microphones, and by comparison, it can be known that ∠POM1 is the microphone with the smallest first type angle, and the microphone corresponding to M1 is set as the main microphone.

The auxiliary microphone can be selected by comparing the angles. The specific process is as follows: determining a plurality of second-type angles ∠PQN corresponding to the main microphone; wherein Q is a coordinate point of other microphones adjacent to the main microphone, and N is a coordinate point of the main microphone; setting the microphone corresponding to the Q point that minimizes the second-type angle ∠PQN as the auxiliary microphone. In the above method, the position of the target device is taken as the position of the sound source, and the main microphone and the auxiliary microphone are selected by comparing the angles so that the angle between the sound source direction and the central axis of the dual microphones is minimized. Please refer to FIG. 4, which is a schematic diagram of an auxiliary microphone selection principle provided in an embodiment of the present application. In FIG. 4, Q1 and Q2 are coordinate points of other microphones adjacent to the main microphone, and N is a coordinate point of the main microphone; by comparison, it can be known that Q1 is the Q point that minimizes the second-type angle, and the microphone corresponding to Q1 can be set as the auxiliary microphone.

As another feasible implementation, the main microphone and the auxiliary microphone can be selected according to the distance between each microphone and the target device. The specific process includes: connecting the target center point and each of the microphones so as to divide an area where the target device is located into a plurality of sub-areas; wherein the target center point is a point having the same distance from all the microphones, and the target center point and all the microphones are in the same plane; determining a sub-area where the target device is located according to the position information, and setting the two microphones corresponding to the sub-area where the target device is located as alternative microphones; setting the alternative microphone closest to the target device as the main microphone; setting the microphone closest to the target device other than the alternative microphone as the auxiliary microphone. Further, if the distance between the target device and the two alternative microphones is the same, any alternative microphone can be selected as the main microphone. In the process of determining the main microphone using the above method, if the target device is located at a boundary line of the sub-area, the microphone closest to the target device is set as the main microphone, and a microphone closest to the target device other than the alternative microphone is selected as the auxiliary microphone.

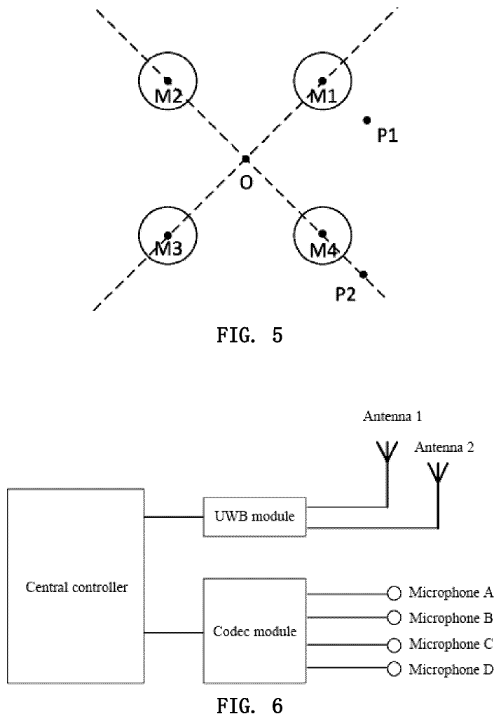

Please refer to FIG. 5 which is a schematic diagram showing a principle of selecting a main microphone and an auxiliary microphone provided by an embodiment of the present application. In FIG. 5, M1, M2, M3 and M4 are microphones, P1 and P2 are two target devices, and O is a target center point that is having the same distance from all the microphones. The target center point O is connected with each of the microphones M1, M2, M3 and M4, and the area where the target device is located is divided into four sub-areas M1OM2, M2OM3, M3OM4 and M4OM1. If P1 is in M4OM1, then M1 and M4 are selected as alternative microphones; if M1 is closest to P1, then M1 is selected as the main microphone. If M2 is closest to P1 among M2 and M3, then M2 is selected as the auxiliary microphone. If P2 is on the boundary line of the sub-area and M4 is closest to P2, then M4 is used as the main microphone and M1 or M3 is used as the auxiliary microphone.

Procedures as described in the above embodiment are explained below through an embodiment in actual application.

As the core device of smart home, smart speakers have multiple attributes such as audio and video, and have achieved initial popularization. In smart speakers, voice assistants are the core features of user interaction and intelligent functions, and have extremely high requirements for the accuracy of human voice collection. UWB technology, relying on its ultra-high positioning accuracy, high bandwidth and anti-interference characteristics, has gradually become the most important wireless communication and IOT control technology in smart homes. Relying on UWB interconnection and positioning of multiple devices, smart home devices can be controlled more accurately.

Please refer to FIG. 6, which is a schematic diagram of the architecture of a smart speaker provided in an embodiment of the present application. The electronic device includes a central control machine, a Codec module, microphones A to D, and a UWB module including antenna 1 and antenna 2. The Codec module is a codec. This embodiment uses a UWB module to obtain the user's position, realize the switching of the beam-forming mode, and improve the accuracy and intelligence of voice command recognition.

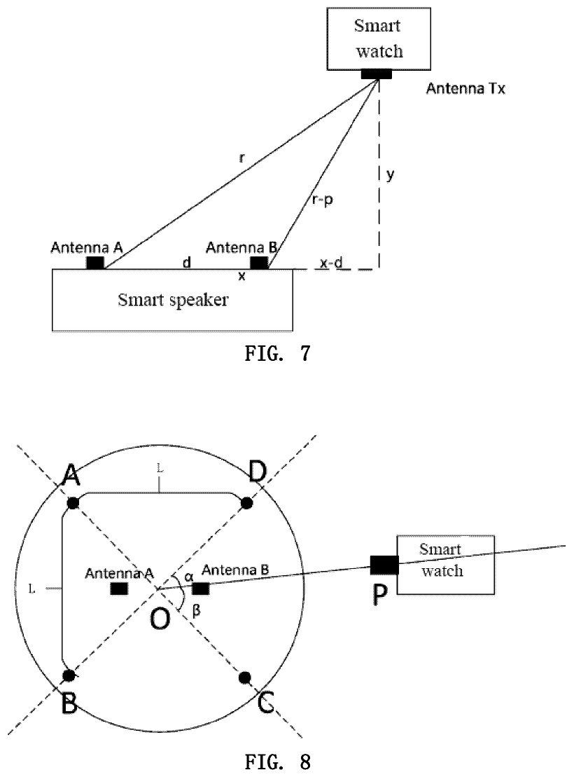

The UWB module has built-in dual antennas, which can detect distance and angle to accurately locate the user's position. The dual antennas in the smart speaker and the antenna in the smart watch complete the coordinate calculation, and then calculate the distance and angle. Please refer to FIG. 7, which is a schematic diagram of a smart speaker positioning principle provided in an embodiment of the present application. In FIG. 7, Antenna A represents antenna 1 and Antenna B represents antenna 2, Antenna Tx represents the antenna of the smart watch, r represents the distance from the antenna of the smart watch to antenna 1, r-p represents the distance from the antenna of the smart watch to antenna 2, y represents the Y-axis difference between the antenna of the smart watch and antenna 2, x represents the X-axis difference between the antenna of the smart watch and antenna 1, x-d represents the X-axis difference between the antenna of the smart watch and antenna 1, and d is the distance between antenna 1 and antenna 2. The X-axis is the direction of a line connecting antenna 1 and antenna 2, and the Y-axis is perpendicular to the X-axis.

This embodiment uses UWB communication positioning between smart speakers based on UWB technology and smart watches and other devices with UWB modules to intelligently switch the microphone selection and switching of beam-forming. Beam-forming technology has clear requirements. First, dual-microphone beam-forming requires the microphones to be spaced consistently, and the angle between the sound source direction and the central axis of the dual microphones (the line connecting antenna 1 and antenna 2) should be as small as possible (generally no more than 30 degrees).

Please refer to FIG. 8, which is a schematic diagram of a smart speaker microphone layout provided in an embodiment of the present application. Taking the microphone array including microphone A, microphone B, microphone C and microphone D as an example, the distance between two adjacent microphones is the same and the four microphones are evenly distributed to ensure the consistency of the algorithm when the dual-microphone beam-forming is switched. In the figure, L is the distance between adjacent microphones, and O is a point having the same distance from the four microphones, that is, the target center point described above. P represents the position of the smart watch, OP is a line connecting the smart watch and point O, α is a included angle between OP and OD, and β is a included angle between OP and OC.

When the UWB module detects that the user is in the COD area, since microphones C and D are closer to the user, microphone C or D is determined as the main microphone of the dual-microphone beam-forming architecture, and by calculating the two angles α and β, when α>β, the user is closer to the C microphone, C is selected as the main microphone, B is selected as the auxiliary microphone, and then C and B are used to construct a dual-microphone beam-forming. Conversely, D is used as the main microphone, A is selected as the auxiliary microphone, and then D and A are used to construct a dual-microphone beam-forming architecture. Similarly, when it is detected that the user is in the DOA, AOB and BOC areas, the corresponding main microphone can be selected and the corresponding dual-microphone beam-forming architecture can be constructed according to this scheme.

The above embodiment can accurately determine the user's precise indoor position through the UWB module of the smart speaker device and the UWB module in the smart watch device carried by the user. This embodiment can dynamically adjust the selection of the main and auxiliary microphones in the beam-forming mechanism of the smart speaker in combination with the user's precise positioning, optimize the performance of the beam-forming architecture, and improve the recognition accuracy of voice commands.

An embodiment of the present application also provides a system for implementing beam-forming function, which can be applied to an electronic device including a positioning device and a microphone array, wherein the microphone array includes at least three microphones, and the system for implementing beam-forming function includes:
a position information determination module configured to collect a position signal of a target device using a positioning device, and determine position information of the target device using the positioning signal;
a microphone selection module configured to select a main microphone and an auxiliary microphone from the microphone array according to the position information; and
a beam-forming function implementation module configured to construct a dual-microphone beam-forming architecture using the main microphone and the auxiliary microphone, and collect sound signals using the dual-microphone beam-forming architecture.

The electronic device provided in this embodiment includes a positioning device and a microphone array, and the microphone array includes at least three microphones. The positioning device is used to collect the positioning signal of the target device, and then the positioning signal is used to determine the positioning information of the target device. According to the positioning information of the target device, a main microphone and an auxiliary microphone are selected from the microphone array, and a dual-microphone beam-forming architecture is constructed using the main microphone and the auxiliary microphone to collect sound signals. This embodiment uses UWB technology to accurately locate the user, and according to the actual position of the user, the dual-microphone beam-forming architecture is rebuilt to improve the accuracy and intelligence of speech recognition. The above scheme can select a main microphone and an auxiliary microphone for constructing the dual-microphone beam-forming architecture according to the position of the target device, which can eliminate the influence of the sound source and the dual microphone included angle on the sound signal collection effect, and improve the stability of the beam-forming function.

Further, the positioning device is a UWB module including a first antenna and a second antenna;

Correspondingly, the position information determination module is configured to respectively use the first antenna and the second antenna of the UWB module to collect UWB signal of the target device; it is also configured to calculate a time difference between the UWB signal respectively arriving at the first antenna and the second antenna; it is also configured to determine position information of the target device based on the time difference and an antenna distance; wherein the antenna distance is a distance between the first antenna and the second antenna.

Furthermore, the microphone selection module is configured to determine a first type angle ∠POM corresponding to the microphone according to the position information; wherein P is a coordinate point of the target device, O is a target center point, and M is a coordinate point of the microphone; the target center point is a point that is having the same distance from all the microphones, and the target center point and all the microphones are in the same plane; the microphone selection module is also configured to set the microphone with the smallest first type angle ∠POM as the main microphone; it is also configured to determine a plurality of second type angles ∠PQN corresponding to the main microphone; wherein Q is a coordinate point of other microphones adjacent to the main microphone, and N is a coordinate point of the main microphone; it is also configured to set the microphone corresponding to the Q point that minimizes the second type angle ∠PQN as the auxiliary microphone.

Furthermore, the microphone selection module is configured to connect the target center point and each of the microphones so as to divide the area where the target device is located into a plurality of sub-areas; wherein the target center point is a point having the same distance from all the microphones, and the target center point and all the microphones are in the same plane; the microphone selection module is also configured to determine a sub-area where the target device is located according to the position information, and set the two microphones corresponding to the sub-area where the target device is located as alternative microphones; it is also configured to set the alternative microphone closest to the target device as the main microphone; it is also configured to set the microphone closest to the target device other than the alternative microphone as the auxiliary microphone.

Furthermore, the microphone selection module is further configured to set the microphone closest to the target device as the main microphone if the target device is located at a boundary line of the sub-area.

The present application also provides a storage medium on which a computer program is stored, and when the computer program is executed, the steps provided in the above embodiment can be implemented. The storage medium may include: a USB flash drive, a mobile hard disk, a read-only memory (ROM), a random access memory (RAM), a magnetic disk or an optical disk, and other media that can store program codes.

The present application also provides an electronic device, the electronic device including a memory, a central controller, a positioning device and a microphone array, the microphone array including at least three microphones, and steps implemented when the central controller calls the computer program in the memory include:
collecting, using the positioning device, a positioning signal of a target device, and determining, using the positioning signal, position information of the target device;
selecting a main microphone and an auxiliary microphone from the microphone array according to the position information; and
constructing a dual-microphone beam-forming architecture using the main microphone and the auxiliary microphone, and collecting sound signals using the dual-microphone beam-forming architecture.

Further, the electronic device is a smart speaker or a mobile phone, and the target device is a smart wearable device or a mobile phone.

Further, the positioning device is a UWB module or a Bluetooth module.

Since the embodiments of the electronic device part of the system part correspond to the embodiments of the method part, please refer to the description of the embodiments of the method part for the embodiments of the system part, which will not be repeated here.

The various embodiments in the specification are described in a progressive manner, and each embodiment focuses on the differences from other embodiments. The same and similar parts between the various embodiments can be referred to each other. For the system disclosed in the embodiment, since it corresponds to the method disclosed in the embodiment, the description is relatively simple, and the relevant parts can be referred to the method part description. It should be pointed out that for those skilled in the art, without departing from the principles of this application, several improvements and modifications can be made to the present application, and these improvements and modifications also fall within the scope of protection of the claims of this application.

It should also be noted that, in this specification, relational terms such as first and second, etc. are only used to distinguish one entity or operation from another entity or operation, and do not necessarily require or imply any such actual relationship or order between these entities or operations. Moreover, the terms “comprise”, “include” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, an element defined by the statement “comprising a . . . ” does not exclude the presence of other identical elements in the process, method, article or device including the element.

1. A method for implementing beam-forming function, applied to an electronic device comprising a positioning device and a microphone array, the microphone array comprising at least three microphones, the method comprising:
collecting, using the positioning device, a positioning signal of a target device, and determining position information of the target device according to the positioning signal;
selecting a main microphone and an auxiliary microphone from the microphone array according to the position information; and
constructing a dual-microphone beam-forming architecture using the main microphone and the auxiliary microphone, and collecting sound signals using the dual-microphone beam-forming architecture.

2. The method for implementing beam-forming function according to claim 1, wherein the positioning device is a UWB module including a first antenna and a second antenna;
the collecting, using the positioning device, a positioning signal of a target device, and determining, using the positioning signal, position information of the target device comprises:
collecting UWB signal of the target device respectively using the first antenna and the second antenna of the UWB module;
calculating a time difference between the UWB signal respectively arriving at the first antenna and the second antenna; and
determining the position information of the target device according to the time difference and an antenna distance, wherein the antenna distance is a distance between the first antenna and the second antenna.

3. The method for implementing beam-forming function according to claim 1, wherein the selecting a main microphone and an auxiliary microphone from the microphone array according to the position information comprises:
determining a first type angle ZPOM corresponding to the microphone according to the position information; wherein P is a coordinate point of the target device, O is a target center point, and M is a coordinate point of the microphone; the target center point is a point having the same distance from all the microphones, and the target center point and all the microphones are in the same plane;
setting the microphone with the smallest first type angle ∠POM as the main microphone;
determining a plurality of second type angles ∠PQN corresponding to the main microphone; wherein Q is a coordinate point of other microphones adjacent to the main microphone, and N is a coordinate point of the main microphone; and
setting the microphone corresponding to the Q point where the second type angle ∠PQN is minimized as the auxiliary microphone.

4. The method for implementing beam-forming function according to claim 1, wherein the selecting a main microphone and an auxiliary microphone from the microphone array according to the position information comprises:
connecting a target center point and each of the microphones so as to divide an area where the target device is located into a plurality of sub-areas; wherein the target center point is a point having the same distance from all the microphones, and the target center point and all the microphones are in the same plane;
determining a sub-area where the target device is located according to the position information, and setting two microphones corresponding to the sub-area where the target device is located as alternative microphones;
setting the alternative microphone closest to the target device as the main microphone; and
setting the microphone closest to the target device except the alternative microphone as the auxiliary microphone.

5. The method for implementing beam-forming function according to claim 4, further comprising:
if the target device is located at a boundary line of the sub-area, setting the microphone closest to the target device as the main microphone.

6. A system for implementing beam-forming function, applied to an electronic device comprising a positioning device and a microphone array, the microphone array comprising at least three microphones, the system comprising:
a position information determination module configured to collect, using the positioning device, a positioning signal of a target device, and determine position information of the target device according to the positioning signal;
a microphone selection module configured to select a main microphone and an auxiliary microphone from the microphone array according to the position information; and
a beam-forming function implementation module configured to construct a dual-microphone beam-forming architecture using the main microphone and the auxiliary microphone, and collect sound signals using the dual-microphone beam-forming architecture.

7. An electronic device, wherein the electronic device comprises a memory, a central controller, a positioning device and a microphone array, wherein the microphone array comprises at least three microphones, and the central controller, when executing a computer program stored on the memory,
collecting, using the positioning device, a positioning signal of a target device, and determining position information of the target device according to the positioning signal;
selecting a main microphone and an auxiliary microphone from the microphone array according to the position information; and
constructing a dual-microphone beam-forming architecture using the main microphone and the auxiliary microphone, and collecting sound signals using the dual-microphone beam-forming architecture.

8. The electronic device according to claim 7, wherein the electronic device is a smart speaker or a mobile phone, and the target device is a smart wearable device or a mobile phone.

9. The electronic device according to claim 7, wherein the positioning device is a UWB module or a Bluetooth module.

10. A non-transitory storage medium, wherein the storage medium stores computer executable instructions, and when the computer executable instructions are loaded and executed by a processor, steps of the method for implementing beam-forming function according to claim 1 are implemented.
